(19) United States
(12) Patent Application Publication
(10) Pub. No.: US 2020/0326483 A1
(43) Pub. Date: Oct. 15, 2020

(54) LARGE-SCALE 3D FIBER CROSS-CONNECT SYSTEM

(71) Applicant: EPCOMM INC, San Francisco, CA (US)

(72) Inventor: Xuezhe Zheng, San Diego, CA (US)

(21) Appl. No.: 16/847,633

(22) Filed: Apr. 13, 2020

Related U.S. Application Data
(60) Provisional application No. 62/832,426, filed on Apr. 11, 2019.

(51) Int. Cl. G02B 6/35

(52) U.S. Cl. CPC G02B 6/356; G02B 6/3516; G02B 6/3556

(57) ABSTRACT

A large-scale 3D fiber cross-connect system is disclosed. The system uses modularized and stackable beam steering units to build input and output arrays that can be expanded to large-scale system of 1000×1000 ports or more. The disclosure provides a two-mirror configuration that minimizes size of the modular beam steering units. With one mirror being fixed on the propagation path of the optical beam and another mirror steerable in a 2D dimension, an any-to-any switching of the large-scale system may be built by stacking the beam steering units over an appropriate distance.

### CROSS-REFERENCE TO RELATED APPLICATION AND CLAIM OF PRIORITY

The present disclosure claims priority under 35 U.S.C. § 119(e) to U.S. Provisional Patent Application Ser. No. 62/832,426, filed on Apr. 11, 2019, entitled Large-Scale 3D Fiber Cross-Connect System. The content of the above identified patent document is incorporated herein by reference.

### TECHNICAL FIELD

This disclosure describes a large-scale 3D fiber cross-connect system. Specifically, this disclosure discloses a system and method of free space fiber switching using modularized beam steering units with integrated 2D scanning mirrors.

### BACKGROUND

The world is more and more connected with optical fibers. IT networking innovations have been mostly applied to layers 0 to 6 of the communication networks while the physical connectivity layer remains unchanged for decades. As the IT infrastructure scales to meet the ever-growing application and service demands, the scale of the physical connectivity layer in data centers, telecom central offices and wireless networks is quickly becoming a huge challenge for manual service and management. An emerging need is a “smart” physical connectivity layer which can help IT services with software defined networking to better utilize the resources and achieve lower cost.

### SUMMARY

According to an embodiment of the present disclosure, a 3D fiber cross-connect system is provided. The 3D fiber cross-connect system includes a first array of beam steering units coupled to a first array of input fibers; and a second array of beam steering units coupled to a second array of output fibers, wherein the first array of the beam steering units and the second array of beam steering units are placed over a distance, wherein an input optical beam reflected by any beam steering unit of the first array is received by any beam steering unit of the second array over the distance. The beam steering unit includes: a fiber collimator configured to convert an input optical signal to an input optical beam; a first mirror configured to reflect the input optical beam to a second mirror; and the second mirror configured to reflect the input optical beam to free space, wherein the first mirror and the second mirror are placed on an optical path of the input optical beam. The first mirror may be a fixed mirror. The second mirror may be adjustable. The second mirror is configured to be adjusted with respect to an X-axis and a Y-axis independently, wherein the X-axis and the Y-axis are orthogonal to each other and to a Z-axis, wherein the Z-axis is substantially parallel to the optical path between the fiber collimator and the first mirror. The second mirror reflects the input optical beam to the free space in an angle range of ±40° with respect of the X-axis and the Y-axis respectively. The second mirror is further configured to reflect an output optical beam to the first mirror, wherein the first mirror is configured to reflect the output optical beam to the collimator, and wherein the collimator is configured to convert the output optical beam to an output optical signal. The output optical beam may be the input optical beam from another beam steering unit. The first mirror is placed at substantially 45° to a propagation direction of the input optical beam and reflects the input optical beam to substantially 90° to the propagation direction. The beam steering unit may be packaged in a bar shape and is optically communicative to an input optical fiber.

According to another embodiment of the present disclosure, a beam steering unit for a 3D fiber cross-connect system is provided. The system includes: a fiber collimator; a first mirror configured to reflect an input optical beam to a second mirror and/or reflect an output optical beam to the fiber collimator; and the second mirror configured to reflect the first optical beam to free space and/or reflect the second optical beam to the first mirror, wherein the input optical beam is converted by the fiber collimator from an input optical signal and wherein the output optical beam is received from the free space. The input optical beam and the output optical beam propagate in opposite directions with regard to an optical path, on which the fiber collimator and the first and second mirrors are located.

Additional features and advantages will be set forth in the detailed description that follows, and in part will be readily apparent to persons skilled in the art from the description or recognized by practicing the condiments as described in the written description and claims hereof, as well as the accompanying drawings.

It is to be understood that the foregoing general description, the following detailed description, and the accompanying drawings are merely and intended to provide an overview or framework to understand the nature and character of the claims.

### BRIEF DESCRIPTION OF THE DRAWINGS

The above-mentioned advantages and other features of the present disclosure will become more apparent to and the disclosure will be better understood by persons skilled in the art with reference to the following description of the embodiments of the disclosure taken in conjunction with the accompanying drawings, wherein:

FIG. 1 illustrates a robotic fiber cross-connect system of the prior art;

FIG. 2a illustrates components and exemplary mechanism thereof of a beam steering unit of a 3D cross-connect switching system according to an embodiment of the present disclosure;

FIG. 2b illustrates the outside configuration of the beam steering unit of a 3D cross-connect switching system according to an embodiment of the present disclosure;

FIG. 3 illustrates the working principle of the 3D fiber cross-connect system using one input BSU with respect to two output BSUs according to an embodiment of the present disclosure;

FIG. 4 illustrates the 3D fiber cross-connect system according to an embodiment of the present disclosure; and

FIG. 5 illustrates a calculated coupling loss for two Gaussian beams with a beam waist size of 1.0 mm (or MFD of 2 mm) versus the distance between the two beam waists.

### DETAILED DESCRIPTION

Several embodiments of the present disclosure are illustrated by the accompanying drawings and described in detail below. In the figures of the accompanying drawings, elements having the same reference numeral designations represent like elements throughout. The drawings are not to scale, unless otherwise noted. The embodiments are described by way of example, and not by limitation. All terminologies and phraseology used herein are for the purpose of illustrating only and should not be understood as limiting. The phrases such as “including”, “comprising”, “having” and other variations thereof are meant to encompass the items as described and their equivalents without excluding any additional items thereof.

Those skilled in the art will understand that the principles of the present disclosure may be implemented with a number of suitably arranged systems and devices that may vary from the embodiments but are within the scope of the present disclosure.

Optical fiber cross-connect is the key element to accomplish a “smart” physical connectivity layer. Over the past couple of decades, various optical switches have been developed for automated fiber cross-connect, but none meets the performance requirements of all the applications in terms of optical loss, switching time and port count. For active networking, circuit switching time in milliseconds and below is a must. The optical loss is also preferred to be less than 3 dB as the standard transceivers are typically made for a link loss budget not considering the additional loss from the insertion of a fiber cross-connect element. 3D MEMS and fiber collimator steering switching technologies are more suitable as they have reasonably fast switching on the order of a few 10s of milliseconds, and reasonably low loss on the order of 2˜3 dB. X. Zheng et al., “Three-Dimensional MEMS Photonic Cross-Connect,” IEEE J. Sel. Top. Quantum Electron., vol. 9, no. 2, pp. 571-578, 2003 Hagood et al, “Beam-steering optical switching apparatus,” U.S. Pat. No. 7,095,916 B2, 2006. However, for applications like automated fiber patch panel or optical distribution frame (ODF), the switching time is not very critical as the fiber patching is traditionally done manually. But the optical loss of each connection has to be very low, <1 dB preferred. Once a fiber connection is made, latching is another requirement to guarantee reliable physical connection against power outage, earthquake, and etc., which is not available currently from MEMS based fiber switching solutions. In addition, large port count is needed for large scale fiber patch panels and ODFs. However, to achieve good loss performance, the size of MEMS mirror has to be large enough to capture the optical beam from a collimated fiber output while the overall array size is limited by the reticle size limit of photo lithography. These constraints limit the port count of a 3D MEMS based fiber switch to <400.

For low cost, low loss fiber switching with latching, robotic fiber switching is a promising solution. A few robotic fiber switches have been invented and commercialized previously. See Wave2wave Solution, ROME 500. http://www.wave-2-wave.com/rome-500.html; Mizukami et al., “200×200 automated optical fiber cross-connect equipment using a fiber-handling robot for optical cabling systems,” in OFC/NFOEC 2005—2005 Conference on Optical Fiber Communication/National Fiber Optic Engineers Conference, 2005, p. OFP5; “Telescent G3 NTM.” [Online]. Available: http://www.telescent.com/products/.

For example, in Wave2wave Solution, supra, two robots connect a pair of LC ferrule based custom optical connectors over a mechanical matrix structure. With the connectors clamped onto the matrix, the connection is latched. The customized connector design has the benefit of achieving reasonably large port count in a compact design. A switch with 256×256 duplex ports is accomplished fitting in a 19″ rack. But customized fiber connector design also resulted in high cost, >$100 per fiber port.

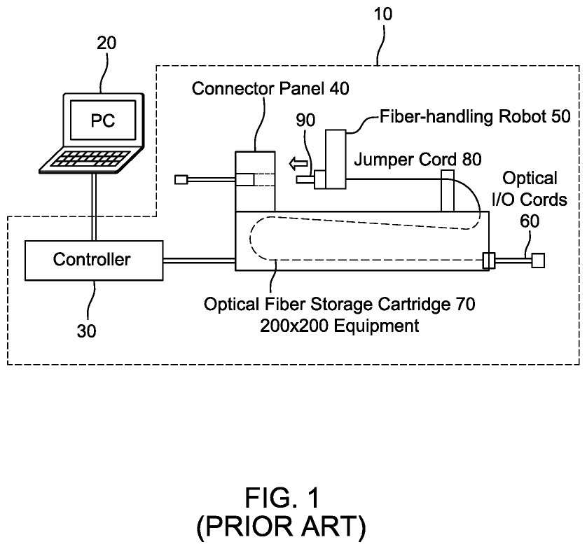

Low cost robotic fiber switching uses standard optical fiber connectors. Mizukami et. al., supra, built a 200×200 automated optical fiber cross-connect system in 2005 using a fiber-handling robot in 2005, which is illustrated in FIG. 1. As illustrated in FIG. 1, the 200×200 cross-connect system 10 is communicatively connected to a PC 20 via a controller 30. The controller 30 provides instructions to the cross-connect system 10 for switching. Essentially half of the fiber I/O cords 60 in Mizukami et. al. are pre-connected to a panel with connectors arranged in a 2D array, while the other half are arranged and stored in a fiber storage cartridge 70 with fiber guiding feature and extra fiber pooling and a one-dimensional linear cord arrangement board. A fiber-handling robot 50 is used to mimic the patching of a telephone operator to pick a fiber jumper cord 80 from the storage cartridge 70 and insert the connector 90 into the destination port on the connector panel 40 to make a connection. With MU type of optical connectors, 200×200 non-blocking cross-connects with low insertion loss of 1 dB or less was achieved. To make a new connection without fiber entangling, the corresponding fiber jumper cord 80 is first disconnected from the connector panel 40 by the robot 50, rewound into the fiber storage cartridge 70 with its connector 90 rearranged on an arrangement board before the robot 50 picks it up again and insert it into a new destination port on the connector panel 40. Consequently, the switching time could be very long.

A. S. Kewitsch from Telescent Inc. later improved the connection reconfiguration control algorithm based on the Theory of Knots and Braids (see “Telescent G3 NTM.”, supra and Kewitsch, supra) to link a 2D input array to a 1D intermediate array, and demonstrated automated cross-connect with reconfigurability in a completely non-blocking fashion and scalable to large port count of 1000×1000. See “Telescent G3 NTM.”, supra. However, the switching time was not improved. On average it would take a few minutes to connect any input to an output port because of the complex control algorithm for minimizing the fiber entangling.

In theory, robotic fiber switching can achieve large scale low loss fiber cross-connect with latching. However, using shared robot(s) means fiber connections have to be made sequentially. Since each connection takes anywhere from a few 10s of seconds to a few minutes, it becomes impractical for a large system where hundreds or even thousands of connections to be configured or reconfigured because it may take days to complete the task.

Therefore, what's needed is a large fiber cross-connect system with low connection loss, latched connections, and switching time independent of the number of connections to make. In this disclosure, we describe a large-scale 3D fiber switch meeting all these requirements. Specifically, free space fiber switching using modularized beam steering units enabled by 2D scanning mirrors is provided.

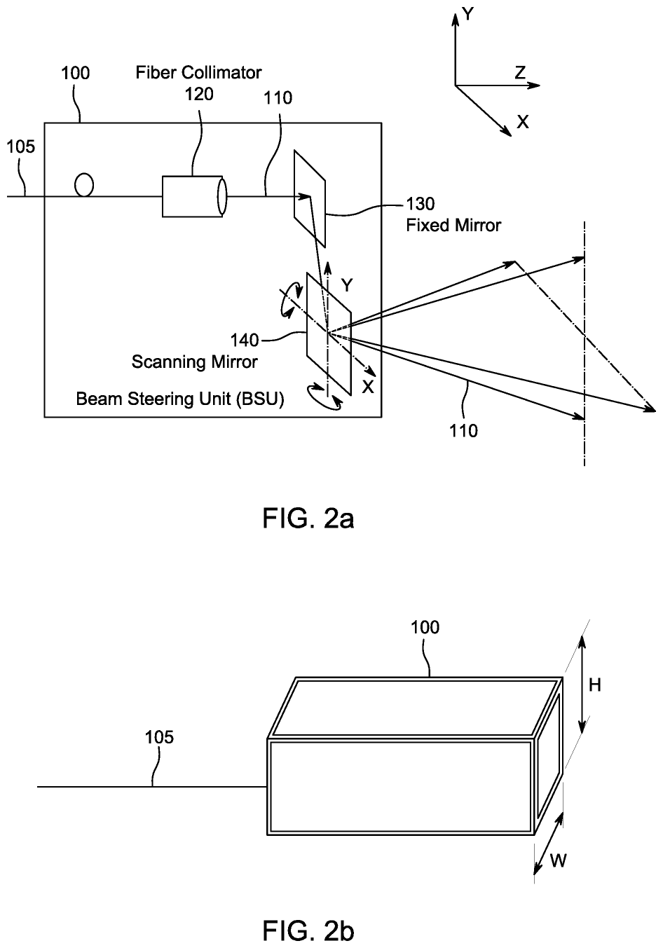

In this disclosure, free space optical beam steering is used to accomplish fiber cross connects. FIGS. 2a-2b illustrates the building block, i.e. beam steering unit 100 (“BSU”), of the 3D cross-connect switching system. The BSU 100 provides an advantageous two-mirror configuration that'll be described in detail as follows. Referring to FIG. 2a, an input optical fiber 105 is provided. Input optical signals for the input port a particular BSU 100 associated with are transmitted in the optical fiber 105. The BSU 100 includes a fiber collimator 120. When an input optical signal reaches the BSU 100, the BSU transforms the input optical signal into free space beam 110 using the fiber collimator 120. The BSU 100 further includes a fixed mirror (FM) 130 that is placed on the optical path of the collimated beam 110. According to an embodiment of the present disclosure, FM 130 is a fixed mirror with a preset angle on the propagation path of the free space beam 110. FM 130 is positioned at an appropriate angle, e.g. positioned 45°, to the collimated beam 110's propagation direction. FM 310 reflects the collimated optical beam 110 to a scanning mirror 140 placed on the propagation path of the reflected free space beam 110. The scanning mirror 140 is an adjustable mirror. The scanning mirror 140 may be set in a parallel angle to the fixed mirror 130 or other angles in its initial state and then be adjusted in order to switch the free space beam 110 from the input port to the destination or target output port over a distance. For example, if the FM 130 is positioned at a 45° to the collimated beam 110, the reflected optical beam 110 will be reflected 90° and reach the scanning mirror. According to an embodiment of the present disclosure, the scanning mirror 140 is configured to rotate around two orthogonal axis, X-axis and Y-axis, independently. As such, the scanning mirror 140 can scan the optical beam 110 into the free space in an increasingly expanded manner as illustrated in FIG. 2a. According to an embodiment of the present disclosure, the scanning mirror 140 is based on piezoelectric actuators, in which case the scanning mirrors will hold their position even when power is lost. As such, the benefit similar to that of latched fiber connections is achieved in the 3D fiber cross-connect system of the present disclosure.

FIG. 2b illustrates the outside configuration of the BSU 100 according to an embodiment of the present disclosure. Referring to FIG. 2b, the BSU 100 is packaged in a rectangular box or a bar. The rectangular configuration makes it easy to stack multiple BSU together in order to make a large-scale switching system, such as a 1000×1000 switching capability. According to an embodiment, the height H and width W, as illustrated in FIG. 2b are equal.

Persons skilled in the art understands that each BSU represents a port of the 3D cross connect switching system. That is each input BSU represents an input port, whereas each output BSU represents an output port. Persons skilled in the art also understand that the orientation of the BSU 100 illustrated in FIG. 2a may be modified, such as rearranging the components with regard to the X-, Y- and Z-axis. The description and illustration provided herein are merely exemplary; other arrangement of the components of the BSU are within the scope and spirit of the present disclosure.

Because of the reversibility of the propagation path of the optical beam 110 in free space, one of the advantages of the BSU 100 is that the BSUs may be used as both input units and output units, hence greatly enhancing the modularity of the BSUs and providing many benefits, such as reduction of the overall complexity of the system and the costs for installation and maintenance. That is, after a free space optical beam 110 travels through the components of an input BSU 100 and is reflected to the free space by an input scanning mirror 140 intended for an output BSU 100 among a wall of output BSU 100, it is received by the intended output BSU 100 placed across the fee space. The optical beam is then received by the scanning mirror 140 of the output BSU 100. The scanning mirror 140 adjusts, such as by a controller, its position with regard to the X- and Y-axis accordingly and reflect the beam to the fixed mirror FM 130 of the output BSU 100, which will send the free space optical beam to the fiber collimator 120 before the optical beam is transformed back to an optical signal that can be transmitted via the optical fiber 105 of the output BSU 100. It is understood by persons skilled in the art that the input BSU and output BSU can be identical, or symmetrically identical.

The present disclosure provides what can be described as a two-mirror configuration, which provides advantages in packaging the BSU into a compact bar-shaped unit with minimized width W and height H, as illustrated above in FIG. 2b. Using large angle micro beam steering mirror for the scanning mirror 140, which can steer micro beams in as large as ±40° angles, the BSUs can be made with very compact size of about 1 cm wide by 1 cm high. The bar shape provides the advantage of easily stacking multiple BSU units, which paves the way for large scaling, the advantage of it will be described in further detail below.

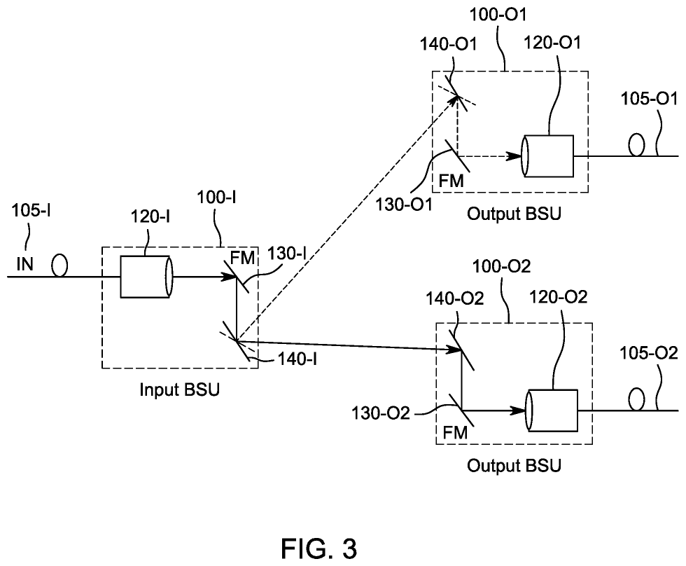

As desc4ribed the above, the input BSUs and output BSUs are placed across each other for free space switching. FIG. 3 illustrates the working principle of the 3D fiber cross-connect system using one input BSU with respect to two output BSUs according to an embodiment of the present disclosure. Referring to FIG. 3, an input beam steering unit 100-I and two output beam steering unit 100-O1 and 100-O2 are provided herein. The output BSUs 100-O1 and -O2 are place upside down comparing to the input BSU 100-I in the illustration. To make a connection between the ports of the input B SU 100-I to the first output BSU 100-O1, the scanning mirror 140-I will adjust its angles in X-axis and Y-axis to send the existing optical beam 110-I to the center of the scanning mirror 140-O1 of the output BSU 100-O1. Depending on the incoming angle of the optical beam 110-I, the scanning mirror 140-O1 then adjusts its angles to send the optical beam 110-I to its corresponding fixed mirror 130-O1. Thereafter, the optical beam is coupled to fiber 105-O1 and transmitted therefrom. To disconnect from the first output port BSU 100-O1 and connect to another output port BSU 100-O2, the scanning mirror 140-I of BSU 100-I will change its angles accordingly that the existing beam 110-I moves from the center of the scanning mirror 140-O1 to the center of the scanning mirror 140-O2. Similarly, the scanning mirror of BSU 140-O2 will adjust its angles accordingly and via the same process described above in connection with BSU 100-O1, the beam 110-I will be transmitted to a new port. By coordinating the movement of the scanning mirrors 140 in both the input BSU and the output BSU, the present disclosure provides fast switching among the input ports and output ports.

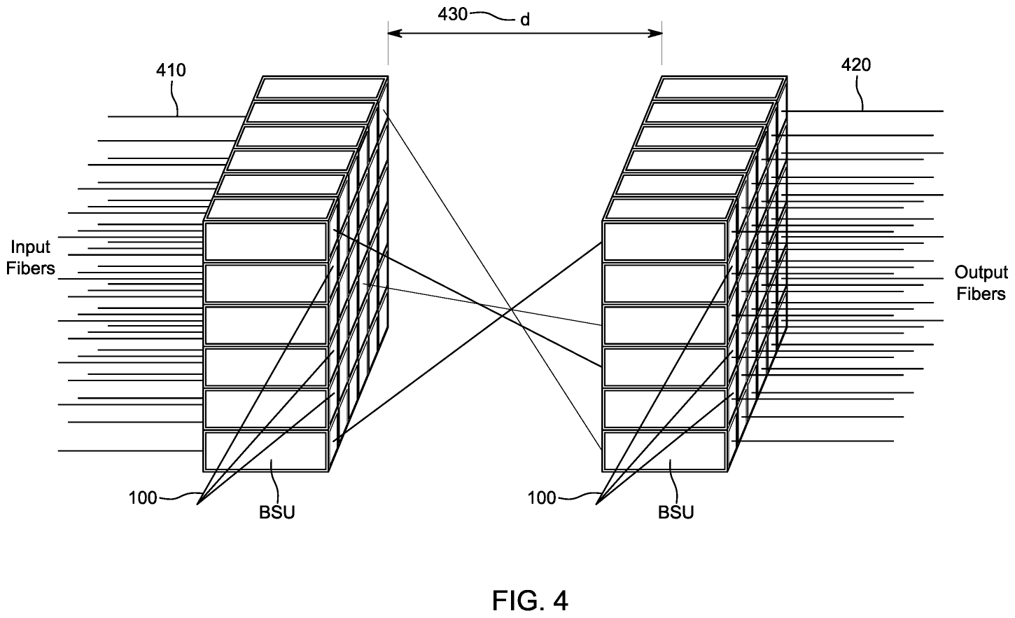

Stacking up a plurality of the bar-shaped input and output BSUs in 2D arrays and placing the input and output arrays face-to-face, a large-scale 3D fiber cross-connect system can be implemented, as illustrated in FIG. 4. Referring to FIG. 4, an input BSU array 410 and output BSU array 420 are placed face-to-face across a distance 430 of the length of d. As described above, the BSUs can be made as small as 1 cm wide by 1 cm high. The distance d over which the input BSU array 410 and the output BSU array 420 are placed is influenced by the size of individual BSU, the size of the arrays, and the scanning mirror 140's maximum reflection angles, because the input BSUs at the corners of the input array 410 should be able to point their beams to the opposite corner output BSU at the output array 420 with the maximum reflection angle of the scanning mirrors 140. For example, with 1×1 cm BSU modules, 32×32 arrays of input BSU and output BSU shall have a distance d of 40 cm for a maximum scanning mirror deflection angle of ±20′.

The input and output arrays 410 and 420 described above are formed in rectangular or square shape using bar shaped BSUs. Persons skilled in the art understand that each BSU 100 may be configured in other shapes, or assembled in other manners, or form an input or output array 410 or 420 in other shapes.

One of the challenges of free space-based fiber cross-connect system is insertion loss. With the input array 410 and output array 420 in a face-to-face configuration illustrated in FIG. 4, the path lengths from any input port to any output port may vary a great deal depending on the position of the ports in their respective arrays. With the same example of an array size of 32×32 for input and output ports and a distance of 40 cm built from 1 cm×1 cm BSUs, the shortest path length between the input and output array is 40 cm (straight path), while the longest path length is approximately 60 cm at the diagonal path. With fixed fiber collimators, different path length results in different fiber-to-fiber coupling insertion loss. According to an embodiment of the present disclosure, the path length induced coupling loss variation may be minimized by using large collimated beam. Persons skilled in the art understand that the optical mode of a single mode fiber can be approximated using a Gaussian beam with a mode-field diameter (MFD, 1/e²) of about 9 um. Therefore, when the optical fibers are single mode fibers, using a proper fiber collimator lens, the small fiber mode can be expanded to a much larger size. For example, a fiber collimator lens with 10 mm focal length can expand the beam to 2 mm MFD. The collimating range (Reyleigh Length) of a Gaussian beam can be expressed as following:

$$L = \frac{{πω}^{2}}{λ} ,$$

in which ω is the Gaussian beam waist size, while λ is the wavelength of the light.

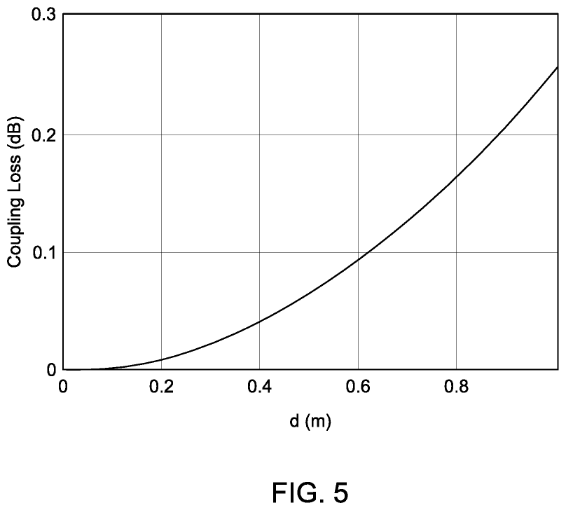

At 2 mm MFD, the collimating range is as large as 2 meters for a wavelength of 1.55 um. Longer collimating range can tolerate larger path length variation for fiber to fiber coupling. FIG. 5 shows the calculated coupling loss for two Gaussian beams with a beam waist size of 1.0 mm (or MFD of 2 mm) versus the distance between the two beam waists. Referring to FIG. 5, the X-axis represents a path length of the cross-connect system in meters and the Y-axis represents the coupling loss in dB. As illustrated in FIG. 5, the coupling loss at a distance of 1 meter is less than 0.3 dB, which is very low for the purpose of controlling insertion loss. From the system design point of view, the variation for the path-length difference range of interest is almost negligible for expanded Gaussian beam. Using high quality fiber collimator, the coupling loss for its designed working distance can be less than 0.5 dB typically. Considering the mirror surface loss and loss introduced by path length variations, a total loss of less than 1 dB is achievable for the proposed large-scale 3D fiber cross-connect system.

With modularized BSUs of the present disclosure, the system can be scaled to larger than 1000×1000 cross-connect fabric seamlessly. Adding identical BSU modules to the input and output arrays will grow the system with more fiber ports. In addition, since all BSUs are individually controlled, connections between any input port to any output port can be made in parallel. Whether one connection is requested, or hundreds of new connections are requested, the amount of time needed to complete the task remains the same.

Although the 2D scanning mirrors are described in the embodiments above, persons skilled in the art understand that the 2D scanning mirror in the BSU can be replaced with two orthogonal 1D scanning mirrors, which are equivalent to the scanning mirror 140 disclosed herein. Further, the scanning mirror can also use normal mechanical actuators with latching, which will hold the scanning mirrors in place and keep the established input-output connection intact when there is power loss.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A beam steering unit for a 3D fiber cross-connect system comprising:
a fiber collimator configured to convert an input optical signal to an input optical beam;
a first mirror configured to reflect the input optical beam to a second mirror; and
the second mirror configured to reflect the input optical beam to free space,
wherein the first mirror and the second mirror are placed on an optical path of the input optical beam.

2. The beam steering unit of claim 1, wherein the first mirror is a fixed mirror.

3. The beam steering unit of claim 1, wherein the second mirror is adjustable.

4. The beam steering unit of claim 3, wherein the second mirror is configured to be adjusted with respect to an X-axis and a Y-axis independently, wherein the X-axis and the Y-axis are orthogonal to each other and to a Z-axis, wherein the Z-axis is substantially parallel to the optical path between the fiber collimator and the first mirror.

5. The beam steering unit of claim 4, wherein the second mirror reflects the input optical beam to the free space in an angle range of ±40° with respect of the X-axis and the Y-axis respectively.

6. The beam steering unit of claim 1, wherein the second mirror is configured to reflect an output optical beam to the first mirror, wherein the first mirror is configured to reflect the output optical beam to the collimator, and wherein the collimator is configured to convert the output optical beam to an output optical signal.

7. The beam steering unit of claim 6, wherein the output optical beam is the input optical beam from another beam steering unit.

8. The beam steering unit of claim 1, wherein the first mirror is placed at substantially 45° degree to a propagation direction of the input optical beam and reflects the input optical beam to substantially 90° to the propagation direction.

9. The beam steering unit of claim 1, wherein the beam steering unit is packaged in a bar shape.

10. The beam steering unit of claim 1, wherein the beam steering unit is optically communicative to an input optical fiber.

11. A 3D fiber cross-connect system, comprising:
a first array of beam steering units coupled to a first array of input fibers; and
a second array of beam steering units coupled to a second array of output fibers,
wherein the first array of the beam steering units and the second array of beam steering units are placed over a distance, wherein an input optical beam reflected by any beam steering unit of the first array is received by any beam steering unit of the second array over the distance.

12. The 3D fiber cross-connect system of claim 11, wherein the beam steering unit comprising:
a fiber collimator configured to convert an input optical signal to an input optical beam;
a first mirror configured to reflect the input optical beam to a second mirror; and
the second mirror configured to reflect the input optical beam to free space,
wherein the first mirror and the second mirror are placed on an optical path of the input optical beam.

13. The 3D fiber cross-connect system of claim 12, wherein the first mirror is a fixed mirror.

14. The 3D fiber cross-connect system of claim 12, wherein the second mirror is a configured to be adjusted with respect to an X-axis and a Y-axis independently, wherein the X-axis and the Y-axis are orthogonal to each other and to a Z-axis, wherein the Z-axis is substantially parallel to the optical path between the fiber collimator and the first mirror.

15. The 3D fiber cross-connect system of claim 12, wherein the second mirror is configured to reflect an output optical beam to the first mirror, wherein the first mirror is configured to reflect the output optical beam to the collimator, and wherein the collimator is configured to convert the output optical beam to an output optical signal.

16. The 3D fiber cross-connect system of claim 15, wherein the output optical beam is the input optical beam from another beam steering unit.

17. The 3D fiber cross-connect system of claim 11, wherein the beam steering unit is packaged in a bar shape.

18. The 3D fiber cross-connect system of claim 11, wherein the first array and the second array have identical dimensions.

19. A beam steering unit for a 3D fiber cross-connect system comprising:
a fiber collimator;
a first mirror configured to reflect an input optical beam to a second mirror and/or reflect an output optical beam to the fiber collimator; and
the second mirror configured to reflect the first optical beam to free space and/or reflect the second optical beam to the first mirror,
wherein the input optical beam is converted by the fiber collimator from an input optical signal and wherein the output optical beam is received from the free space.

20. The beam steering unit of claim 19, wherein the input optical beam and the output optical beam propagate in opposite directions with regard to an optical path, on which the fiber collimator and the first and second mirrors are located.
